(19) United States
(12) Patent Application Publication
(10) Pub. No.: US 2025/0180142 A1
(43) Pub. Date: Jun. 5, 2025

(54) NOISE DAMPER INTEGRATED SOLENOID VALVE

(71) Applicant: PADMINI VNA MECHATRONICS LIMITED, Gurgaon (IN)

(72) Inventors: Kabir BHANDARI, Gurgaon (IN); Varun KUMAR, Gurgaon (IN); Anurag SETHI, Gurgaon (IN); Sahil SINGLA, Gurgaon (IN)

(21) Appl. No.: 18/964,457

(22) Filed: Dec. 1, 2024

(30) Foreign Application Priority Data
Dec. 1, 2023 (IN) 202311081729

(51) Int. Cl. F16K 47/02; F16K 31/06

(52) U.S. Cl. CPC F16K 47/02; F16K 31/0655

(57) ABSTRACT

The present invention discloses a noise damper integrated solenoid valve (20) that comprises of a housing assembly (5), a fixed core (3), a coil (2), a spring (6), a noise damper (7), a plurality of electrical connections (4) and a plunger (1). The noise damper (7) minimizes the noise during the operation of a solenoid valve, absorbs shocks, vibrations resulting in a quieter and less disruptive performance.

### FIELD OF THE INVENTION

The present invention relates to the field of noise damper integrated solenoid valve. More particularly, the present invention relates to a solenoid valve integrated with a noise damper to minimize the noise produced by the movement of the internal components.

### BACKGROUND OF THE INVENTION

A solenoid valve is an electromechanical device that controls the flow of fluid, typically liquids or gases. The solenoid valve is suitable for various applications including medical equipment, automobile, power generation and irrigation systems. The solenoid valve comes in various types such as fuel tank isolation valve, purge control solenoid valve etc. The solenoid valve operates using the principles of electromagnetism and consists of a coil, a plunger, a spring and a fixed core. The solenoid typically consists of a coil of wire wound around a core. When the electric current flows through the coil, a magnetic field is generated around the coil which attracts the plunger as the plunger is made up of ferromagnetic material. The plunger is attracted towards the center of the coil to gain the kinetic energy. When the plunger reaches the maximum point of attraction, the plunger hits the fixed core at the center of the solenoid. However, the process of plunger hitting fixed core produces annoying sound that create a sense of discomfort in the vehicle and the industries.

To address the issue of annoying sounds generated by the plunger hitting the fixed core in a solenoid valve, there is a requirement of implementing a noise reduction mechanism. The mechanism of adjusting magnetic field strength generated by the solenoid coil. The strength influence the speed and force with which the plunger hits the fixed core, potentially minimize noise. However, the mechanism impact on valve performance of the solenoid valve as striking balance between noise reduction and maintaining efficient valve operation is crucial.

Besides that, another noise damping is to implement electronic control to modulate the speed and force of the plunger movement that is achieved through the pulse-width modulation. The electronic control mechanism adds complexity to the solenoid valve that increases manufacturing costs. Therefore, there is a requirement of incorporating a noise damper having a material that is cost-efficient.

U.S. Pat. No. 9,004,883B2 discloses a low noise, high efficiency solenoid pump includes a housing containing a hollow electromagnetic coil. Within the coil resides a pump assembly defining a tubular body having a pair of opposed ends which respectively include an inlet or suction port and an outlet or pressure port and within which a plunger or piston resides. The piston is biased in opposite directions by a pair of opposed compression springs. A first compression spring limits and arrests travel of the piston during the suction or return stroke and a second compression spring limits travel of the piston during the pumping stroke and returns the piston after the pumping stroke. The piston includes a first check valve that opens to allow hydraulic fluid into a pumping chamber during the suction stroke and closes during the pumping stroke to cause fluid to be pumped out of the pumping chamber. A second check valve opens to allow pumped fluid to exit the pumping chamber and the pump body through the outlet or pressure port and closes to inhibit reverse flow. However, the invention fails to provide the teaching about the noise damper that is cost-efficient.

CN204717051U discloses a low-noise solenoid valve is provided to suppress the noise of an electronic solenoid valve by absorbing the noise due to the shock of a plunger in two or three stages. A valve body having a fluid inlet and a fluid outlet has a seat member fixing part on the inner bottom face. A seat member fixed on the seat member fixing part has a path in the center. A plunger having a steel ball for opening the path of the seat member moved upward and downward depending on the excited state of a solenoid coil. An elastic spring installed on the outer face of the seat member absorbs noise when the plunger moves downward. An elastic spring formed at an upper portion of the plunger secondly absorbs shock when the plunger moves upward. However, implementing the multi-stage in low-noise solenoid valve increases the complexity and cost of the solenoid valve. Besides that, the inclusion of multiple stages impact the response time of the solenoid valve.

Therefore, due to above mentioned drawbacks, there is a requirement of a simpler and cost-efficient noise damper integrated solenoid valve that reduces audible noise and vibrations with enhanced performance in terms of response time and reliability for various applications.

### OBJECT OF THE INVENTION

The main object of the present invention is to provide a noise damper integrated solenoid valve to minimize vibrations and reduce noise during the operation of solenoid valve.

Another object of the present invention is to provide a noise damper integrated solenoid valve in order to create a sense of comfort in the vehicle's cabin or in the industries.

Yet another object of the present invention is to provide a noise damper integrated solenoid valve to prevent the direct contact between the metal surfaces of plunger and the fixed core in order to ensure smooth and controlled movement of the components.

Yet another object of the present invention is to provide a noise damper integrated solenoid valve to utilize versatile dimensions of the noise damper that is simpler and cost efficient.

Still another object of the present invention is to provide a noise damper integrated solenoid valve having rubber molding that is easily integrated, resilient and durable.

### SUMMARY OF THE INVENTION

The present invention relates to a noise damper integrated solenoid valve to provide efficient and precise fluid control and solve the issue of noise in the solenoid valve to ensure a quieter and comfortable environment.

In an embodiment, the present invention provide a noise damper integrated solenoid valve comprises of: a plunger, a coil, a fixed core, a plurality of electrical connections, a housing assembly, and a spring, wherein: said housing assembly includes said coil wounded around said fixed core, when electrically energized produces a magnetic field which energizes said plunger that is attached to said spring moves in a linear motion to open and close said solenoid valve. The plunger is fitted with a noise damper to prevent direct contact between metal surface of said plunger and said fixed core to effectively attenuate the vibrations and sound emissions. The noise damper is preferably installed by press-fitting, over-molding and snap lock. The noise damper is preferably made up of plastic and rubber. The noise damper incorporated rubber molding that acts as an insulator, preventing the transmission of vibrations from the solenoid valve.

The above objects and advantages of the present invention will become apparent from the hereinafter set forth brief description of the drawings, detailed description of the invention, and claims appended herewith.

### BRIEF DESCRIPTION OF THE DRAWING

An understanding of the noise damper integrated solenoid valve of the present invention may be obtained by reference to the following drawing:

FIG. 1 is a schematic view of a conventional solenoid valve according to an embodiment of the present invention.

FIG. 2 is a schematic view of a noise damper integrated solenoid valve according to an embodiment of the present invention.

FIGS. 3(a) and 3(b) are perspective views of noise damper according to an embodiment of the present invention.

FIGS. 4(a) and 4(b) are cross-sectional views of noise damper integrated solenoid valve according to an embodiment of the present invention.

FIGS. 5(a) and 5(b) are sectional views of noise damper fitted with the plunger according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention relates to a noise damper integrated solenoid valve in which a plunger body moves in linear motion to open or close the solenoid valve that effectively minimizes the vibrations and sound emissions during the operation.

In an embodiment, the present invention provide a noise damper integrated solenoid valve comprises of: a plunger, a coil, a fixed core, a plurality of electrical connections, a housing assembly, and a spring, wherein: said housing assembly includes said coil wounded around said fixed core, when electrically energized produces a magnetic field which energizes said plunger that is attached to said spring moves in a linear motion to open and close said solenoid valve. The plunger is fitted with a noise damper to prevent direct contact between metal surface of said plunger and said fixed core to effectively attenuate the vibrations and sound emissions. The noise damper is preferably installed by press-fitting, over-molding and snap lock. The noise damper is preferably made up of plastic and rubber. The noise damper incorporated rubber molding that acts as an insulator, preventing the transmission of vibrations from the solenoid valve.

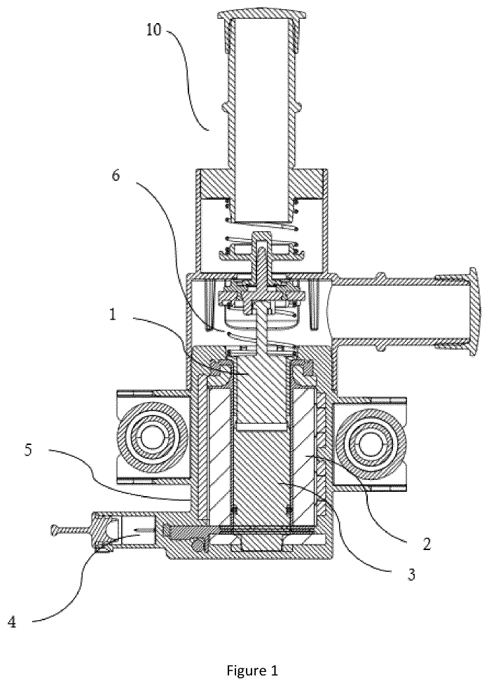

FIG. 1 is a schematic view of a conventional solenoid valve according to an embodiment of the present invention. The conventional solenoid valve (10) comprises of a plunger (1), a coil (2), a fixed core (3), a plurality of electrical connections (4), a housing assembly (5) and a spring (6). The fixed core (3) is preferably made up of ferromagnetic material. When electrical current is applied to the coil (2), the magnetic field is generated that allows the movement of the plunger (1) to control the positioning of the sealing elements in order to allow or block the flow of fluid. The spring (6) keeps the valve in closed position when there is no magnetic field and return the valve in default position when there is magnetic field. Due to the plunger (1) hitting fixed core (3) an annoying sound is produced that creates a sense of discomfort in the vehicle and it is of concern to the industries.

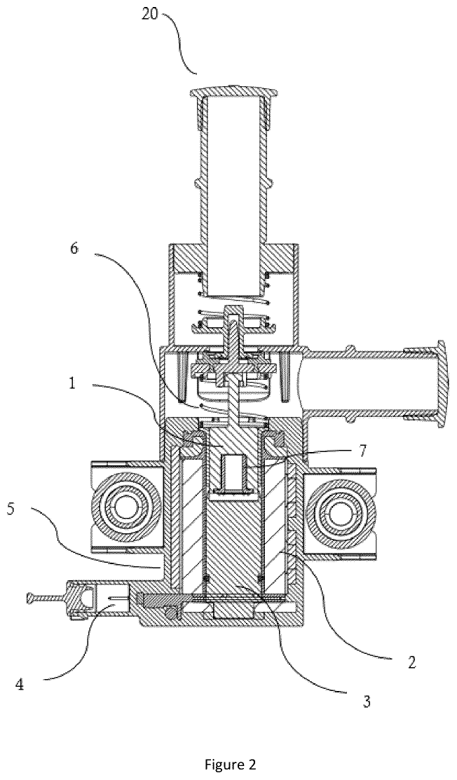

FIG. 2 is a schematic view of a noise damper integrated solenoid valve according to an embodiment of the present invention. The noise damper integrated solenoid valve (20) comprises of: a plunger (1); a coil (2); a fixed core (3); a plurality of electrical connections (4); a housing assembly (5); and a spring (6); wherein: said housing assembly (5) includes said coil (2) wounded around said fixed core (3), when electrically energized produces a magnetic field which energizes said plunger (1) that is attached to said spring (6) moves in a linear motion to open and close said solenoid valve (20). The plunger (1) is fitted with a noise damper (7) to prevent direct contact between metal surface of said plunger (1) and said fixed core (3) to effectively attenuate the vibrations and sound emissions. The noise damper (7) is preferably installed by press-fitting, over-molding and snap locking. The noise damper (7) incorporated rubber molding (8) that acts as an insulator, preventing the transmission of vibrations from the solenoid valve.

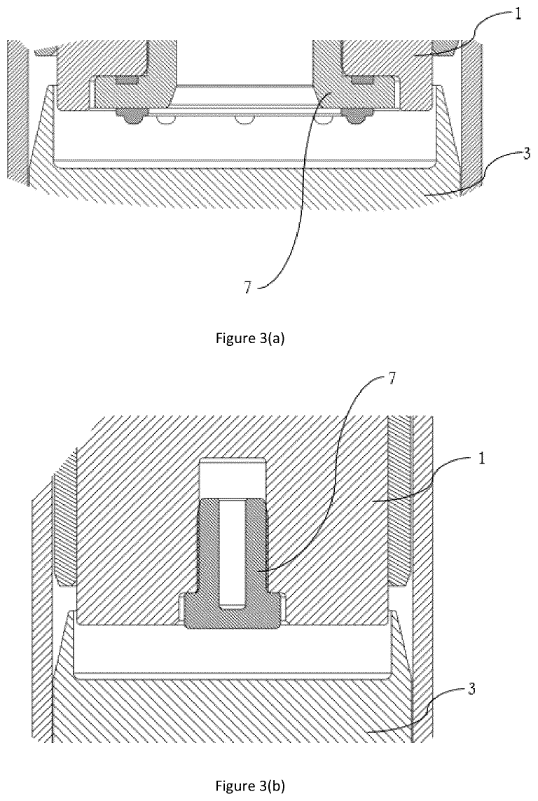

FIGS. 3(a) and 3(b) are perspective views of noise damper according to an embodiment of the present invention. The solenoid energizes plunger (1) to hit the fixed core (3) that produces annoying sounds and the sounds are audible in the cabin of the vehicle that create a sense of discomfort. The noise damper (7) is fitted between the metal surfaces of the plunger (1) and the fixed core (3) to reduce the annoying sound in the cabin of the vehicle. The noise damper (7) is made up of different materials such as plastic, rubber etc. The noise damper (7) is installed in the plunger (1) by various methods such as press-fitting, over-molding, snap lock etc.

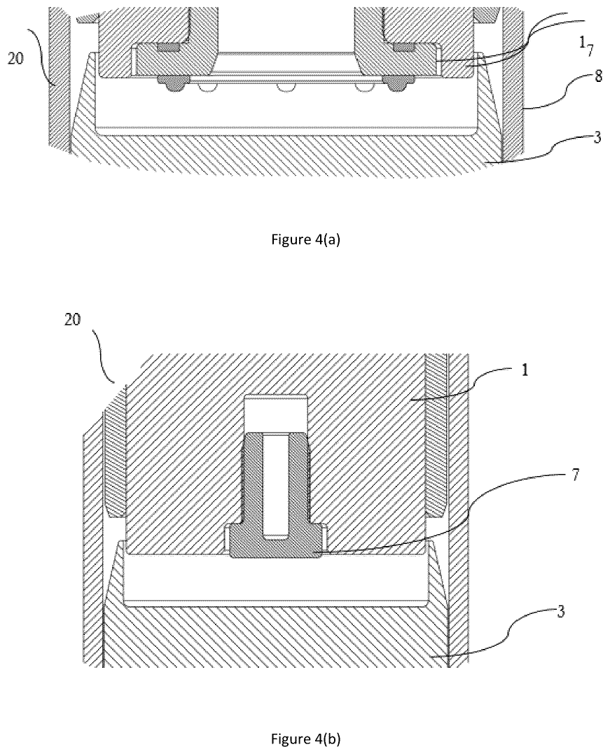

FIGS. 4(a) and 4(b) are cross-sectional views of noise damper integrated solenoid valve according to an embodiment of the present invention. The noise damper integrated solenoid valve (20) efficiently controls the fluid and resolves the issue of noise. The noise damper (7) significantly lowers vibration and noise during valve operation. The noise damper (7) acts as a barrier between the plunger (1) and the fixed core (3) to provide a seamless and noise-free solution. The rubber molding (8) in the noise damper (7) that acts as an effective damper as the rubber has an ability to absorb vibrations effectively that dampens the mechanical vibrations generated during the movement of the plunger (1) hitting the fixed core (3).

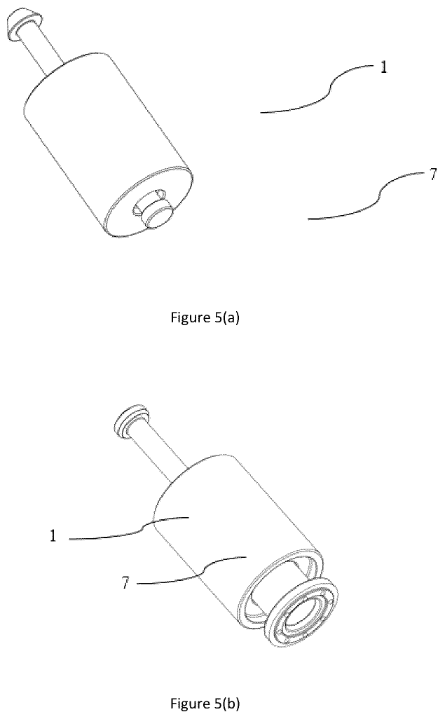

FIGS. 5(a) and 5(b) are sectional views of noise damper fitted with the plunger in according to an embodiment of the present invention. The press fitting and over molding process are commonly utilized to integrate noise damper (7) into the plunger (1) of the solenoid valve (20). The press fitting process mechanically presses the noise damper (7) into the plunger (1) by applying force. The press fitting process provides a tight and secure fit in which no additional materials required. The over molding is a process in which a material i.e. rubber is molded over the plunger (1) and the noise damper (7) that creates a single, integrated component with the noise damper (7) encapsulated within the molded material. The over molding process ensures a seamless and integrated solenoid valve.

### EXAMPLE 1

### Working of the Invention

The present invention provides a noise damper integrated solenoid valve for reduction of noise generated during the operation of the solenoid valve which contributes to a more pleasant and user-friendly experience.

The noise damper integrated solenoid valve (20) comprises of a housing assembly (5), a fixed core (3), a coil (2), a spring (6), a noise damper (7), a plurality of electrical connections (4) and a plunger (1). The coil (2) of wire is wound around a core (3). When an electric current flows through the coil (2), the magnetic field is generated around the coil (2). The magnetic field energizes the plunger (1) as the plunger (1) is preferably made up of ferromagnetic material and the plunger (1) starts moving. The plunger (1) gets attracted towards the center of the coil (2) and the plunger (1) gains kinetic energy. When the plunger (1) reaches the maximum point of attraction, the plunger (1) hits the fixed core (3) that produces annoying sounds. This impact initiates a mechanical action such as opening a valve. Therefore, the noise damper (7) is fitted with the plunger (1) to prevent the direct contact between a metal surface of the plunger (1) and the fixed core (3) that ensures the solenoid valve operation smoothly and quietly.

### EXAMPLE 2

### Experimentation Details

The present invention provides a noise damper integrated solenoid valve for reduction of noise generated during the operation of the solenoid valve. In table 1, the actuation noise and release noise of solenoid valve without the noise damper is depicted. However in table 2 the actuation noise and release noise of a solenoid valve integrated with the noise damper is depicted. Further, from both the table it is clearly asserted that there is significant reduction in noise when the solenoid valve is integrated with the noise damper.

TABLE 1
The actuation noise and release noise of
a solenoid valve without the noise damper

| | Sample 1 | Sample 2 | Sample 3 |
|---|---|---|---|
| Actuation Noise (dB) | 62.4 | 62.4 | 62.4 |
| Release Noise (dB) | 42.1 | 42.1 | 42.1 |

TABLE 2
The actuation noise and release noise of a solenoid
valve integrated with the noise damper

| | Sample 1 | Sample 2 | Sample 3 |
|---|---|---|---|
| Actuation Noise (dB) | 52.5 | 52.5 | 52.5 |
| Release Noise (dB) | 34.5 | 34.5 | 34.5 |

Therefore, the present invention provides a noise damper integrated solenoid valve that effectively control noise-free fluid for durable and consistent performance of solenoid valve in various industries.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A noise damper integrated solenoid valve (20) comprises of:
a plunger (1);
a coil (2);
a fixed core (3);
a plurality of electrical connections (4);
a housing assembly (5); and
a spring (6);
wherein:
said housing assembly (5) includes said coil (2) wounded around said fixed core (3), when electrically energized produces a magnetic field which energizes said plunger (1) that is attached to said spring (6) moves in a linear motion to open and close said solenoid valve (20); and
said plunger (1) is fitted with a noise damper (7) which includes a molding (8) to prevent direct contact between metal surface of said plunger (1) and said fixed core (3) to effectively attenuate the vibrations and sound emissions.

2. The noise damper integrated solenoid valve (20) as claimed in claim 1, wherein said noise damper (7) is made of material which includes but not limited to plastic, rubber or combination of plastic and rubber.

3. The noise damper integrated solenoid valve (20) as claimed in claim 1, wherein said plunger (1) is fitted with said noise damper (7) through plurality of processes which include but are not limited to press fitting, snap lock and over molding process.

4. The noise damper integrated solenoid valve (20) as claimed in claim 1, wherein said noise damper (7) is preferably of customizable shape and size.

5. The noise damper integrated solenoid valve (20) as claimed in claim 1, wherein said noise damper (7) include said molding (8) which is preferably made of rubber that acts as an insulator, preventing the transmission of vibrations.
